(19) United States
(12) Patent Application Publication
(10) Pub. No.: US 2009/0235025 A1
(43) Pub. Date: Sep. 17, 2009

(54) MEMORY CARD CAPABLE OF REDUCING POWER CONSUMPTION

(76) Inventor: Atsushi KONDO, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/470,600

(22) Filed: May 22, 2009

Related U.S. Application Data
(63) Continuation of application No. PCT/JP2008/066026, filed on Aug. 29, 2008.

(30) Foreign Application Priority Data
Sep. 28, 2007 (JP) 2007-255450

(51) Int. Cl. G06F 12/00; G06F 13/00; G06F 12/02

(52) U.S. Cl. 711/115; 710/52; 711/103; 711/E12.001; 711/E12.008

(57) ABSTRACT

A control section controls a nonvolatile memory. A plurality of data terminals, and a command terminal are connected to a host, and transfer and receive data and a command to and from the host. A buffer memory temporarily stores the data. The control section outputs a filled state of the buffer memory to a first data terminal of the plural data terminals as a write busy signal indicating a write busy period by a block write command operation in which the number of blocks to be transferred is defined, receives a token issued by the block write command, and outputs the write busy signal indicating the write busy period to the first data terminal until an end of the token processing.

### CROSS REFERENCE TO RELATED APPLICATIONS

This is a Continuation Application of PCT Application No. PCT/JP2008/066026, filed Aug. 29, 2008, which was published under PCT Article 21(2) in English.

This application is based upon and claims the benefit of priority from prior Japanese Patent Application No. 2007-255450, filed Sep. 28, 2007, the entire contents of which are incorporated herein by reference.

### BACKGROUND OF THE INVENTION

1. Field of the Invention

The present invention relates to a memory card provided with a nonvolatile memory such as a NAND flash memory and, more particularly, to an interface with a host.

2. Description of the Related Art

For example, as for a command of an SD™ memory card, it is possible to switch a command mode, and extend a new command to an undefined command code, to thereby define the new command. As the extended command mode, for example, a read/write command for carrying a secure token is defined in the Mobile Commerce Extension standard.

In a block write operation command (CMD35) as the extension-defined command, the SD memory card can output a filled state indicating that the buffer memory is full as a busy signal to a signal line (hereinafter referred to as an interface signal line) connected to the host. However, the busy signal indicating an authentication processing period of the secure token carried by the extended command cannot be output to the interface signal line. Accordingly, it is necessary for the host to repeat status read (CMD36) of the secure token in order to know the end of the processing of the secure token.

Further, in the block write operation (CMD25) in which the number of blocks to be transferred is not defined in an argument, a stop command (CMD12) is issued, and the write operation is stopped at an end of transfer of the block. The host can issue a stop command in the busy period of the state where the buffer memory is full. Further, the SD memory card can output a busy signal indicating a write processing period in which data is written to the NAND flash memory (hereinafter referred to as the NAND memory) after the stop command to the interface signal line. The busy signal is output subsequently to a busy signal indicating the state where the buffer memory is full. However, when an error occurs in the write processing of writing data to the NAND memory, the SD card cannot output a write error signal indicating an error status to the interface signal line. Accordingly, the host must issue status read (CMD13) of the block write operation in order to know whether or not the data has been normally written to the NAND memory.

As described above, in the present SD memory card standard (see, for example, SD Specification Part 1, Physical Layer Simplified Specification Version 2.0, Sep. 25, 2006, SD Group (Matsushita Electric Industrial Co., Ltd. (Panasonic), SanDisk Corporation, Toshiba Corporation) Technical Committee SD Card Association.), the busy signal indicating the processing period of the secure token cannot be output to the interface signal line, and hence the following problems are caused.

As for the secure token, a challenge and a response in the mutual authentication processing are repeated, and a busy wait of a very long time occurs in the signature verification processing, signature generation processing, and the like in many cases. The above status read becomes a software loop in the host CPU. For this reason, the load on the CPU due to polling is increased, and the power consumption is increased.

Further, in the SD memory card, an I/O buffer transistor of the interface section operates for a long time, and hence the power consumption is increased.

Furthermore, in the present SD memory card standard, in a block write operation in which the number of blocks to be transferred is not defined in an argument, a write error signal cannot be output to the interface signal line as a result of the processing of writing data to the NAND memory. Thus, the host must perform the status read operation for reading the write result each time a multi-block data write operation for writing multi-block data to the NAND memory is performed. Accordingly, this becomes a factor of lowering of the throughput of data write, and an increase in the load on the CPU of the host.

### BRIEF SUMMARY OF THE INVENTION

An object of the present invention is to provide a memory card which makes it possible to output a busy signal indicating a processing period of a secure token, and a write error signal to a data terminal, can reduce a load on a host CPU, and can also reduce the power consumption of the host and the memory card.

According to a first aspect of the invention, there is provided a memory card comprising: a nonvolatile memory; a control section configured to control the nonvolatile memory; a plurality of data terminals connected to a host, configured to transfer and receive data to and from the host; a command terminal connected to the host, configured to transfer and receive a command to and from the host; and a buffer memory configured to temporarily store the data, wherein the control section outputs a filled state of the buffer memory to a first data terminal of the plural data terminals as a write busy signal indicating a write busy period by a block write command operation in which the number of blocks to be transferred is defined, receives a token issued by the block write command, and outputs the write busy signal indicating the write busy period to the first data terminal until an end of the token processing.

According to a second aspect of the invention, there is provided a memory card comprising: a nonvolatile memory; a control section configured to control the nonvolatile memory; a plurality of data terminals connected to a host, configured to transfer and receive data to and from the host; a command terminal connected to the host, configured to transfer and receive a command to and from the host; and a buffer memory configured to temporarily store the data, wherein the control section outputs a filled state of the buffer memory to a first data terminal of the plural data terminals as a write busy signal indicating a write busy period by a block write command operation in which the number of blocks to be transferred is defined, receives a token issued by the block write command, and outputs a busy signal indicating a processing period of the token to a second data terminal of the plural data terminals.

According to a third aspect of the invention, there is provided a memory card comprising: a nonvolatile memory; a control section configured to control the nonvolatile memory; a plurality of data terminals connected to a host, configured to transfer and receive data to and from the host; a command terminal connected to the host, configured to transfer and receive a command to and from the host; and a buffer memory configured to temporarily store the data, wherein the control section outputs a filled state of the buffer memory to a first data terminal of the plural data terminals as a write busy signal indicating a write busy period by a block write command operation in which the number of blocks to be transferred is defined, receives a token issued by the block write command, outputs a write busy signal indicating the write busy period to the first data terminal until an end of token processing, and outputs a busy signal indicating a processing period of the token to a second data terminal of the plural data terminals.

### BRIEF DESCRIPTION OF THE SEVERAL VIEWS OF THE DRAWING

FIG. 1 is a block diagram schematically showing interface connection between a host and a memory card.

FIG. 2 is a block diagram showing an example an SD memory card 1 to which embodiments are applied.

FIG. 3 is a view showing the APDU transfer timing of the present invention.

FIG. 4 is a block diagram showing a first embodiment.

FIG. 5 is a timing chart showing an operation of the first embodiment.

FIG. 6 is a block diagram showing a second embodiment.

FIG. 7 is a timing chart showing an operation of the second embodiment.

FIG. 8 is a timing chart showing operations of the second and a third embodiment.

FIG. 9 is a block diagram showing the third embodiment.

FIG. 10 is a timing chart showing the operation of the third embodiment.

### DETAILED DESCRIPTION OF THE INVENTION

Embodiments of the present invention will be described below with reference to the accompanying drawings.

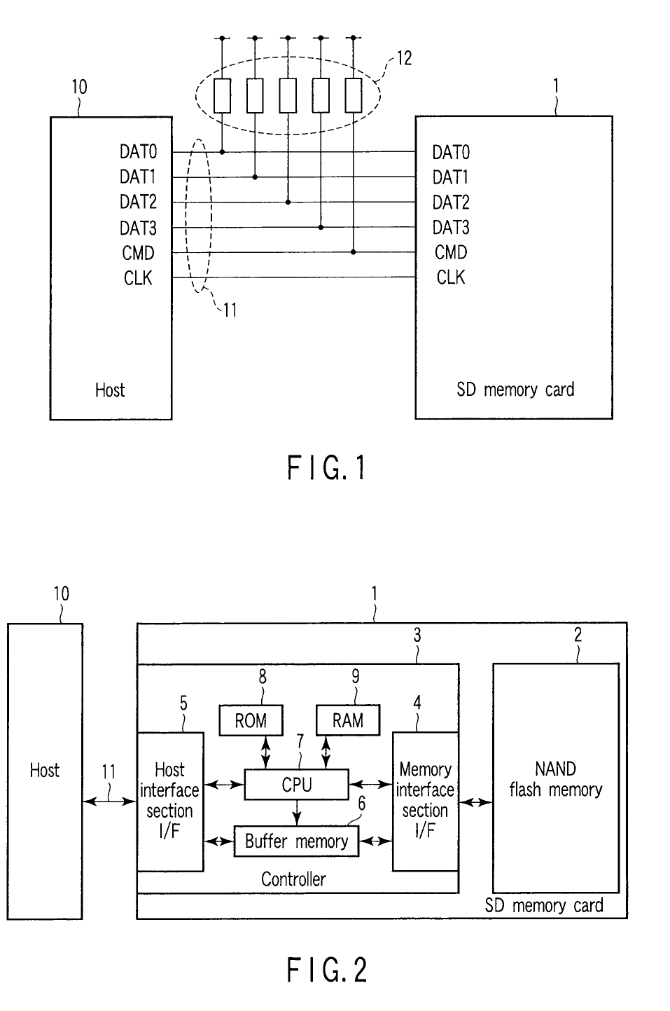

FIG. 1 schematically shows the interface connection between a host and a memory card.

An SD memory card 1 and a host device (hereinafter referred to as a host) 10 are connected to each other by a plurality of interface signal lines 11. The interface signal lines 11 are constituted of four data signal lines, DAT0, DAT1, DAT2, and DAT3, a command signal line CMD, and a clock signal line CLK. The data signal lines DAT0, DAT1, DAT2, and DAT3, and the command signal line CMD are bidirectional signal lines, and are in a high-impedance state. Thus, the data signal lines DAT0, DAT1, DAT2, and DAT3, and the command signal line CMD are connected to a power source through a plurality of pull-up resistors 12.

Incidentally, the SD memory card 1 is connected to the host 10 through connecting terminals. That is, the data signal lines DAT0, DAT1, DAT2, and DAT3, the command signal line CMD, and the clock signal line CLK are respectively connected to data terminals, a command terminal, and a clock terminal of each of the SD memory card and the host.

The host 10 includes hardware and software (system) for accessing the SD memory card 1. The host 10 accesses the SD memory card 1 such as data read, data write, data erase, and the like.

When the SD memory card 1 is connected to the host 10, the power source is supplied thereto, and performs processing corresponding to the access from the host 10. Regarding the access such as data read, data write, data erase, and the like, the SD memory card 1 performs processing such as mapping of the physical address and the logical address, error correction using ECC, and access to the NAND memory.

FIG. 2 shows an example of the SD memory card 1 to which the embodiments are applied. The SD memory card 1 includes a NAND memory (NAND flash memory) 2, and a controller 3. The controller 3 includes a memory interface section 4, a host interface section 5, a buffer memory 6, a CPU 7, a ROM (read only memory) 8, and a RAM (random access memory) 9.

The memory interface section 4 performs interface processing between the controller 3 and the NAND memory 2. The host interface section 5 performs interface processing between the controller 3 and the host 10.

The buffer memory 6 temporarily stores therein a certain amount of data (for example, data of one page) when data sent from the host is written to the NAND memory 2, or temporarily stores therein a certain amount of data when data read from the NAND memory 2 is sent to the host 10.

The CPU 7 manages the operations of the entire memory card 1. For example when the power source is supplied to the SD memory card 1, the CPU 7 starts the processing in accordance with firmware (control program) stored in the ROM 8. That is, the CPU 7 prepares various tables (management data) necessary for the processing on the RAM 9, receives a write command, a read command, and an erase command from the host, and accesses the corresponding region on the NAND memory, converts a logical address and a physical address from the host when the CPU 7 accesses the NAND memory 2, or controls data transfer processing through the buffer memory 6.

The ROM 8 is a memory for storing a control program or the like used by the CPU 7. The RAM 9 is a volatile memory which is used as a working area of the CPU 7, and stores various tables and the like.

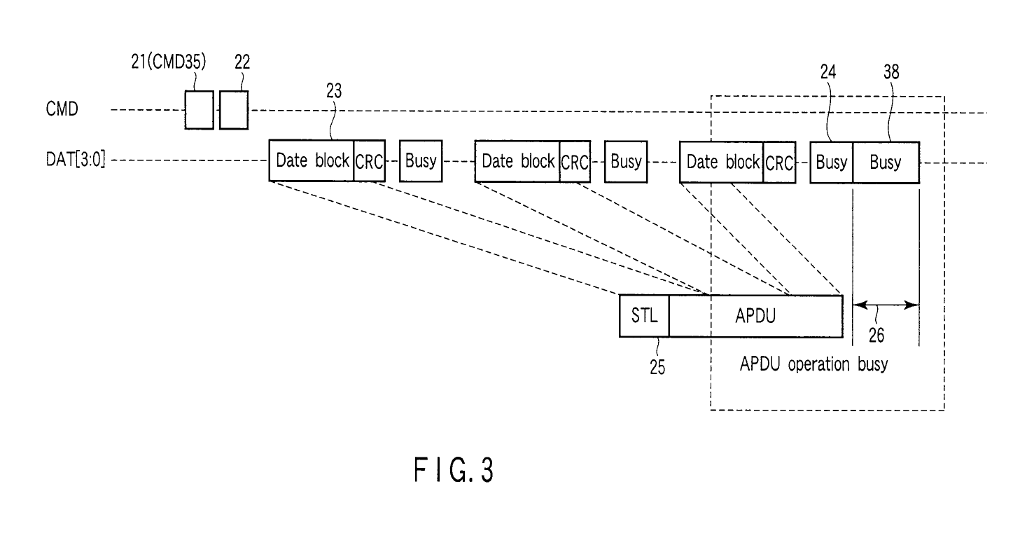

FIG. 3 is a view showing the APDU (application protocol data unit) transfer timing of the present invention.

The secure token used in the mobile commerce extension standard is encapsulated by the APDU 25 defined by ISO/IEC7816. An STL (secure token length) field is provided in the header of the APDU, and the length of the APDU 25 is indicated by the STL field.

The APDU 25 is transferred from the host 10 by a data block 23 of the extension-defined multi-block write command (CMD35) 21. The SD memory card 1 returns a response 22 in response to the multi-block write command 21, and outputs a busy signal 24 indicating a busy status of the buffer memory 6.

The APDU processing period 26 indicates a time for which the SD memory card 1 performs authentication processing or the like of the secure token.

In the embodiments, the SD memory card 1 outputs a busy signal 38 indicating the APDU processing period 26 to the interface signal line. The output function of the busy signal 38 will be described in the following embodiment.

### First Embodiment

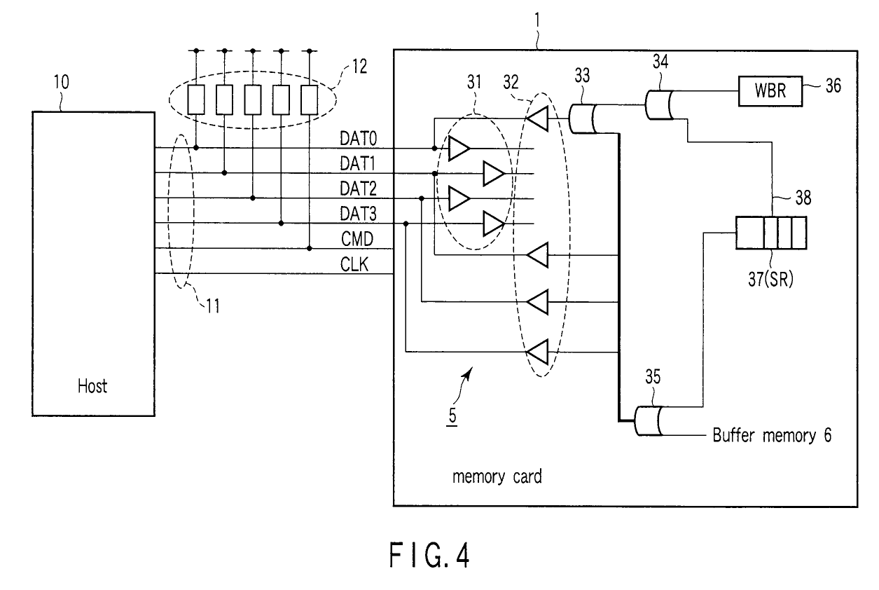

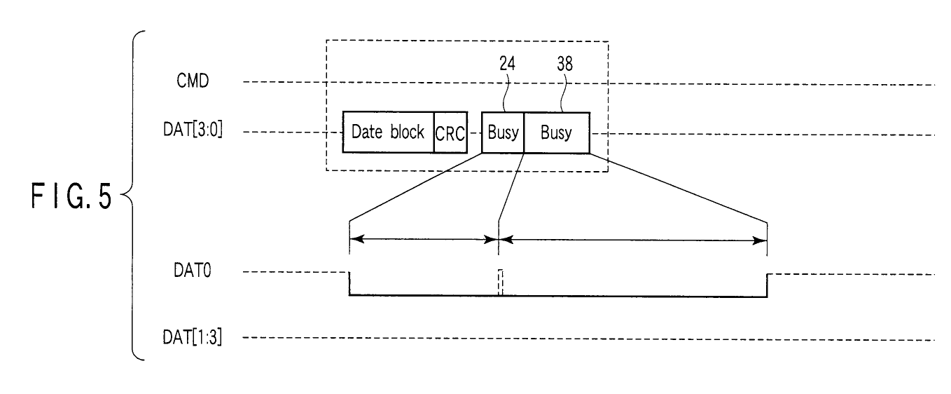

FIG. 4 shows a first embodiment, and shows the configuration of a host interface section 5 constituting an interface between the host 10 and the SD memory card 1 shown in FIGS. 1 and 2. In FIG. 4, the same parts as those in FIGS. 1 and 2 are denoted by the same reference symbols.

In the host interface section 5 shown in FIG. 4, of the interface signal lines 11, the data signal lines DAT0 to DAT3 are connected to the buffer memory 6 shown in FIG. 2 through an input buffer constituted of a plurality of transistors (not shown).

A status register (SR) 37 holds a busy signal indicating a busy status of the buffer memory 6, a write busy signal indicating a processing state of write to the NAND memory 2, a processing status (APDU busy signal) of the secure token encapsulated by the APDU, and the like.

A write busy register (WBR) 36 holds a copy of a write busy signal indicating that data is written to the NAND memory 2 held in the status register 37.

A logic circuit 34 selects and outputs one of an output signal of the write busy register 36, and an APDU busy signal 38 output from the status register 37.

A logic circuit 35 selects and outputs one of an output signal of the status register 37, and output data of the buffer memory 6. That is, in the case of status read, the output signal of the status register 37 is selected, and in the case of data read, the output data of the buffer memory 6 is selected.

One of the output signals of the logic circuit 35 is supplied to the logic circuit 33 together with the output signal of the logic circuit 34. An output signal of the logic circuit 33, and the remaining output signal of the logic circuit 35 are supplied to the data signal lines DAT0 to DAT3 through an output buffer 32 constituted of, for example, a tri-state buffer.

In the configuration described above, write data supplied from the host 10 is written to the buffer memory 6 through the input buffer 31. When the buffer memory 6 becomes full, or while write processing of writing data to the NAND memory 2 is performed by the issuance of a stop command (CMD12), a busy signal is output from the write busy register 36. This busy signal is supplied to one element of the output buffer 32 through the logic circuits 34 and 33, and is then output from the output buffer 32 to the data signal line DAT0 of the interface signal lines 11.

Further, the first embodiment is provided with the following function.

The processing status (busy status) of the secure token encapsulated by the APDU is held in the status register 37. The busy signal 38 indicating the APDU processing period, and output from the status register 37, and the busy signal output from the write busy register 36 are supplied to the logic circuit 34. The logic circuit 34 is provided with a function of prolonging the busy signal, and the write busy signal is prolonged by a period corresponding to the APDU busy signal 38. The prolonged busy signal is output to the data signal line DAT0 from the output buffer 32.

FIG. 5 shows the output timing of the APDU busy signal 38 according to the first embodiment. Subsequently to the busy signal 24 of the buffer memory 6, the APDU busy signal 38 indicating the APDU processing period 26 is output to the data signal line DAT0.

When the busy signal 24 of the buffer memory 6 is ended, the logic circuit 34 outputs the APDU busy signal 38 without a break. That is, it is necessary that the level of the data signal line DAT0 should be changed from the high level to the low level in accordance with the generation of the busy signal 24 of the buffer memory 6, and, when the busy signal 24 of the buffer memory 6 is cancelled, the level of the data signal line DAT0 should be kept at the low level in accordance with the APDU busy signal 38 indicating the APDU processing period 26. That is, as shown in FIG. 5, it is necessary that when the busy signal 24 of the buffer memory 6 is cancelled, the level of the data signal line DAT0 should not be temporarily raised to the high level as indicated by the broken line. Accordingly, the logic circuit 34 includes, for example, a set/reset type latch circuit. This latch circuit is set in accordance with the generation of the busy signal 24 of the buffer memory 6, and is reset in accordance with the end of the APDU busy signal 38 indicating the APDU processing period 26.

Incidentally, implementation of the logic circuit 34 is not limited to this. The logic circuit 34 can be constituted by, for example, a selector circuit in which the input is selectively switched by the CPU 7. Further, each of the logic circuits 33 and 35 can be constituted by, for example, a selector circuit as in the case of the logic circuit 34.

According to the first embodiment described above, the busy signal 24 indicating that the buffer memory 6 is full is prolonged to the end of the busy signal 38 indicating the APDU processing period with respect to the issuance of the secure token encapsulated by the APDU by the extension-defined block write command, and the prolonged busy signal is output to the data signal line DAT0. As a result of this, the host 10 need not perform polling for status read during the APDU processing period as in the conventional case. The host 10 has only to perform the normal interrupt processing when the APDU processing period is ended, that is, in accordance with the inactivation of the busy signal 38. Accordingly, it is possible to prevent the load on the CPU from being increased by the polling for status read, and reduce the power consumption.

Further, it is unnecessary to perform polling, and hence it is possible, in the SD memory card 1, to reduce the power consumption of the input buffer, and the output buffer of the host interface section 5 corresponding to the polling period.

Further, it is also unnecessary to repeat polling with respect to the firmware of the host having the conventional function, and the polling has only to be performed once when the APDU processing period is ended. As a result of this, the same effect can be obtained with respect to a host having the conventional function.

### Second Embodiment

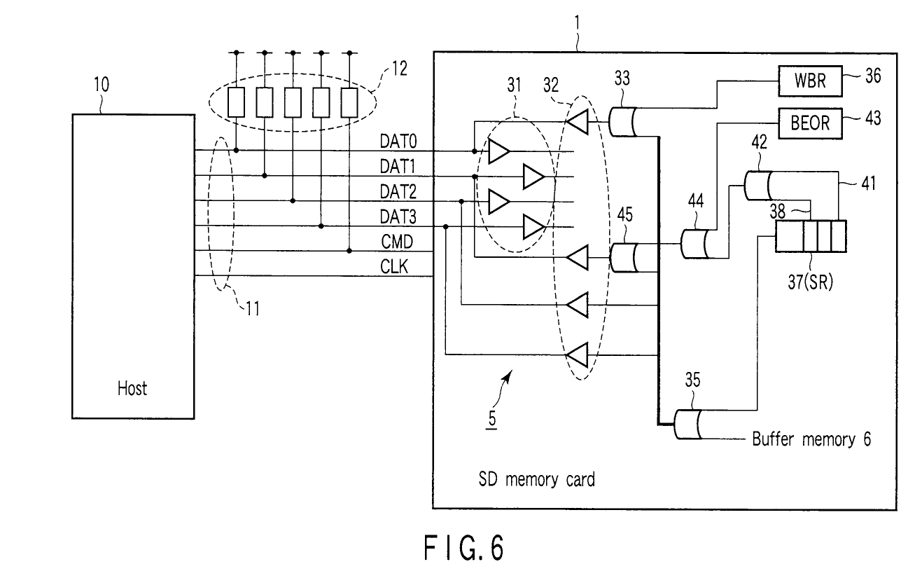

FIG. 6 shows the configuration of a host interface section 5 of an SD memory card according to a second embodiment. In FIG. 6, the same parts as those in FIG. 4 are denoted by the same reference symbols.

In the first embodiment, the busy signal 24 indicating that the buffer memory 6 is full is prolonged to the end of the busy signal 38 indicating the APDU processing period with respect to the issuance of the secure token encapsulated by the APDU by the extension-defined block write command, and the prolonged busy signal is output to the data signal line DAT0.

Conversely, in the second embodiment, a busy signal 24 indicating that a buffer memory 6 is full is output to a data signal line DAT0, and a busy signal 38 indicating an APDU processing period or, for example, an error signal as a write error status appearing when write is forcibly stopped in an ordinary block write operation is output to, for example, a data signal line DAT1 other than the data signal line DAT0.

Further, in the second embodiment, a function of outputting the busy signal 38 or the error signal to the data signal line DAT1 can be set available or unavailable by a host 10.

In FIG. 6, a write error signal 41 as a write error status of the APDU busy signal 38 and a NAND memory 2 held in a status register 37 is supplied to a logic circuit 42. A busy error output capability register (BEOR) 43 holds data for setting whether or not the APDU busy signal and the write error signal are to be output to the data signal line DAT1. The busy error output capability register 43 is mapped onto, for example, an SD card configuration register (SCR) (not shown).

A value of the busy error output capability register 43 after the register 43 is reset is disabled. Further, when the busy error output capability register (BEOR) 43 is enabled, predetermined data is written to the busy error output capability register (BEOR) 43 by using, for example, a register write command at the initialization time of the SD memory card.

The APDU busy signal 38 and the write error signal 41 held in the status register 37 are supplied to the logic circuit 42. The logic circuit 42 selects one of the APDU busy signal 38 and the write error signal 41. An output signal of the logic circuit 42 and a busy error output enable signal output from the busy error output capability register 43 are supplied to a logic circuit 44. This logic circuit 44 is a gate circuit which outputs the output signal of the logic circuit 42 when the busy error output enable signal is true. The output signal of the logic circuit 44 is supplied to a logic circuit 45 together with one of the data signals output from the logic circuit 35. The logic circuit 45 selects one of the output signal of the logic circuit 44 and data signal output from the logic circuit 35. An output end of the logic circuit 45 is connected to a data signal line DAT1 through an output buffer 32. Each of these logic circuits 42, 44, and 45 can be constituted of, for example, a selector circuit.

Incidentally, there is also an embodiment in which the busy error output capability register 43 outputs an APDU busy output capability bit and a write error output capability bit independently of each other. In this case (although not shown), the ADPU busy output capability bit output gates the ADPU busy signal 38 (corresponding to the logic circuit 44), and the write error output capability bit output gates the write error signal 41 (corresponding to the logic circuit 44). These outputs become the inputs to the logic circuit 42, and one of these is selected, and the output of the logic circuit 42 becomes the input to the logic circuit 45.

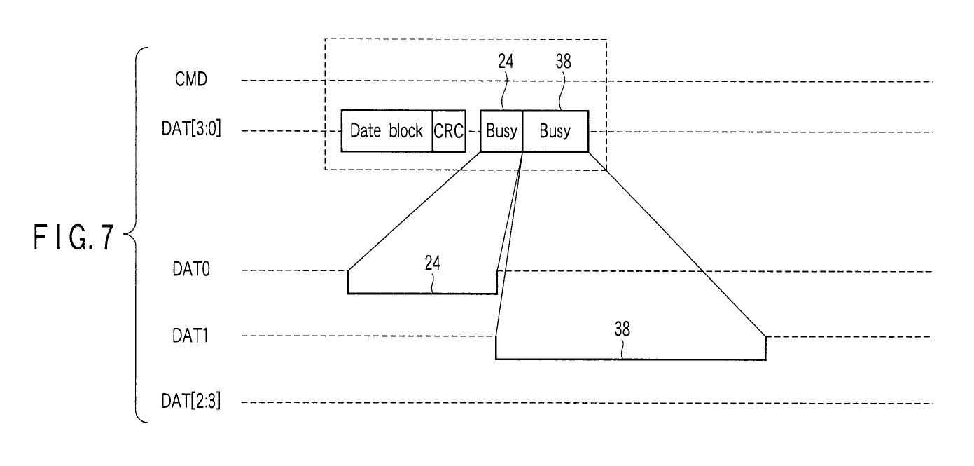

Next, an operation of the second embodiment will be described below with reference to the timing chart shown in FIG. 7.

Like the first embodiment, write data from the host 10 is written to the buffer memory 6 through the input buffer 31. When the buffer memory becomes full, or while write processing of writing data to the NAND memory 2 is performed by the issuance of a stop command (CMD12), a busy signal 24 is output from the write busy register 36. This busy signal 24 is supplied to the data signal line DAT0 through the logic circuit 33 and the output buffer 32.

Incidentally, a busy signal indicating the busy status of the buffer memory 6 held in the status register 37, and a busy signal indicating a busy status of write processing of writing data to the NAND memory 2 are copied into the write busy register 36.

Further, status data read from the status register 37 by a status read command (CMD36, CMD13) (not shown) is output from the output buffer 32 to the data signal lines DAT0 to DAT3 through the logic circuit 35. At this time, status data output from the data signal line DAT0 is supplied to the output buffer 32 through the logic circuit 45.

On the other hand, the processing status (busy status) of the secure token encapsulated by the APDU is held in the status register 37. The busy signal 38 indicating the APDU processing period is output from the status register 37.

Further, in the case of the block write command (CMD25) in which the number of blocks to be transferred is not defined in an argument, the write operation is stopped by the stop command (CMD12) at an end of transfer of the block as described previously. The status of the processing of writing data to the NAND memory 2 by the stop command is also held in the status register 37. A write error signal 41 is output from the status register 37.

When the busy error output capability register 43 is set in an on state (enable), the logic circuit 44 outputs the APDU busy signal 38 or the write error signal 41 selected by the logic circuit 42. The output signal of the logic circuit 44 is supplied to the data signal line DAT1 through the logic circuit 45 and the output buffer 32. Therefore, when the APDU busy signal 38 is selected as shown in FIG. 7, the data signal line DAT1 changes to the low level in accordance with the APDU busy signal 38, and the host 10 can know that the SD memory card 1 is in the APDU processing state from the signal level of the data signal line DAT1.

As shown in FIG. 7, in the second embodiment, the busy signal 24 of the buffer memory 6 is output to the data signal line DAT0. Subsequently to this, the busy signal 38 indicating the APDU processing period 26 is output to the data signal line DAT1. That is, the busy signal 24 of the buffer memory 6 is output to the data signal line DAT0 as in the case of the first embodiment. Conversely, the busy signal 38 indicating the APDU processing period 26 is output to the data signal line DAT1.

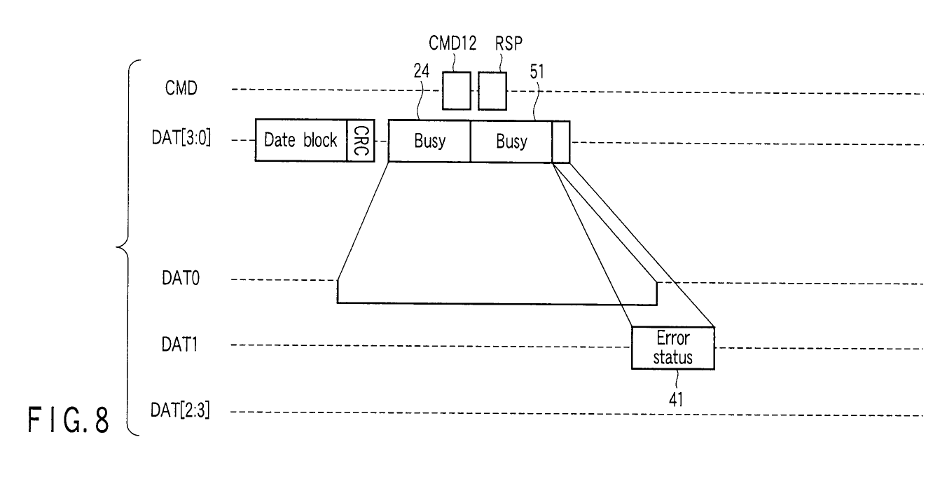

FIG. 8 is a view showing the output timing of the error status in the case where a block write command (CMD25) in which the number of blocks to be transferred is not defined in an argument. This timing chart is common to both the second embodiment and a third embodiment to be described later.

As shown in FIG. 8, when a stop command (CMD12) is issued from the host 10 subsequently to the busy signal 24 of the buffer memory 6, the write busy register 36 outputs a write busy signal 51 of the NAND memory 2. The write busy signal 51 is output to the data signal line DAT0 through the logic circuit 33 and the output buffer 32. That is, after the stop command (CMD12) subsequent to the busy signal 24 of the buffer memory 6, the busy signal 24 is prolonged to the end of the write busy signal 51. During this period, the data signal line DAT0 is held in the active state, i.e., at the low level.

A write error signal 41, which is the write processing status of the NAND flash memory 2, is output before the prolonged busy signal becomes inactive (from the low level to the high level). As for the output timing of the write error signal 41, the signal 41 is output, for example, two clocks before the prolonged busy signal rises from the low level to the high level.

By setting the output timing as described above, the host can securely capture the write error signal 41 at the rise (from the low level to the high level) timing of the prolonged busy signal.

The write error signal 41 is output to the data signal line DAT1 through the logic circuits 42, 44, and 45, and the output buffer 32.

Incidentally, the stop command (CMD12) is issued in the period of the busy signal 24, and a response (RSP) thereof is returned from the SD memory card 1 to the host 10.

According to the second embodiment described above, when the busy signal of the buffer memory 6 is output to the data signal line DAT0, and the secure token encapsulated by the APDU by the extension-defined block write command, the APDU busy signal is output to the data signal line DAT1 different from the data signal line DAT0. Therefore, the host 10 need not repeat issuance of a read command of the processing status of the secure token, and has only to perform interrupt processing when the busy signal of the data signal line DAT1 is raised to the high level indicating inactiveness. Accordingly, polling need not be repeated, and hence the load on the CPU can be reduced, and the power consumption can also be reduced. Further, it is possible to reduce the power consumption of the transistors constituting the input buffer 31 and the output buffer 32 of the host interface section 5.

Furthermore, the busy signal of the buffer memory 6 and the busy signal of the APDU processing are output independently of each other, and hence there is an advantage that these interrupt event processing operations can be independently programmed in the host 10.

Moreover, in the block write operation in which the number of blocks to be transferred is not defined in an argument, after the stop command (CMD12) subsequent to the busy signal 24 of the buffer memory 6, the busy signal 24 is prolonged to the end of the write busy signal 51. During this period, the data signal line DAT0 is held in the active state (low level). Further, the write error signal 41 as the error status of the NAND memory 2 is output to the data signal line DAT1 immediately before (for example, two clocks before) the data signal line DAT0 is brought into the inactive state. As a result of this, the host 10 can perform necessary processing on the basis of the write error signal 41 without performing status read of the write result that has been needed to be performed each time a multi-block data write operation is performed. Accordingly, the data write throughput can be improved. Moreover, it is possible to obtain an excellent effect of reducing the load on the CPU of the host 10, and reducing the power consumption.

Further, the busy error output capability register 43 is disabled with respect to the conventional host, and the function of the second embodiment is disabled. Accordingly, the conventional busy signal is output to the conventional host, thereby exerting no harmful influence on the conventional host.

### Third Embodiment

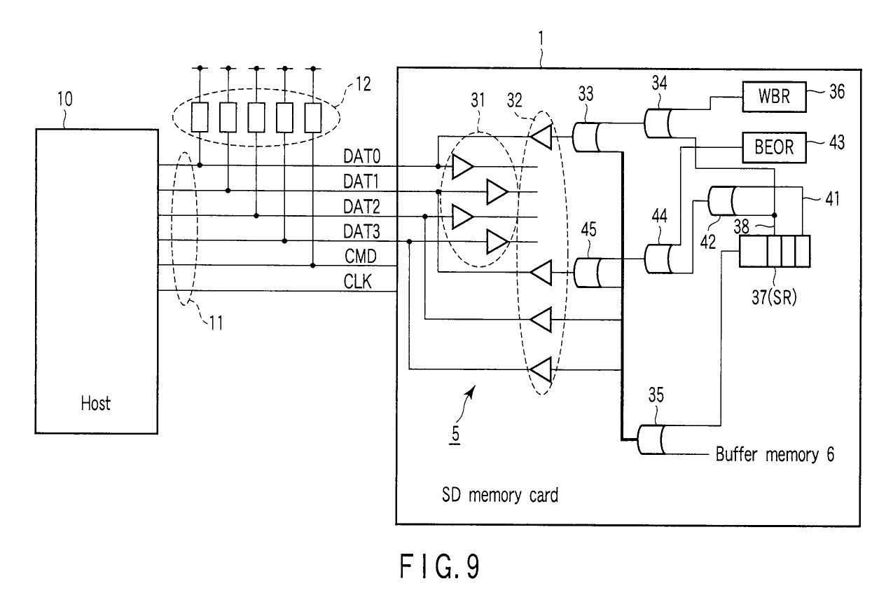

FIG. 9 shows the configuration of a host interface section 5 of an SD memory card according to a third embodiment. In FIG. 9, the same parts as those in FIGS. 4 and 6 are denoted by the same reference symbols.

The third embodiment is formed by combining the first and second embodiments with each other. That is, in FIG. 9, an output signal of a write busy register 36, and an APDU busy signal 38 output from a status register 37 are supplied to a logic circuit 34. The logic circuit 34 selects and outputs one of these signals.

A logic circuit 35 selects and outputs one of the output signal of the status register 37, and output data of a buffer memory 6. One of the output signals of the logic circuit 35 is supplied to a logic circuit 33 together with the output signal of the logic circuit 34. An output signal of the logic circuit 33 is supplied to a data signal line DAT0 through an output buffer 32.

Further, an APDU busy signal 38 and a write error signal 41 held in the status register 37 are supplied to a logic circuit 42. The logic circuit 42 selects one of the APDU busy signal 38 and the write error signal 41. The output signal of the logic circuit 42 and a busy error output enable signal output from a busy error output capability register 43 are supplied to a logic circuit 44. The logic circuit 44 is a gate circuit which outputs the output signal of the logic circuit 42 when the busy error output enable signal is true. The output signal of the logic circuit 44 is supplied to a logic circuit 45 together with one of the data signals output from the logic circuit 35. The logic circuit 45 selects one of the output signal of the logic circuit 44 and data signal output from the logic circuit 35. An output end of the logic circuit 45 is connected to a data signal line DAT1 through the output buffer 32.

Next, an operation of the third embodiment will be described below.

Write data supplied from a host 10 is written to the buffer memory through an input buffer 31. When the buffer memory becomes full, or while write processing of writing data to the NAND memory 2 is performed by the issuance of a stop command (CMD12), a busy signal is output from the write busy register 36. This busy signal is output to the data signal line DAT0 through the logic circuit 33 for selecting the read data and the busy signal, and the output buffer 32. Status data read from the status register 37 by a status read command (CMD36, CMD13) is supplied through the logic circuit 35 from the output buffer 32 to the data signal lines DAT0 to DAT3.

On the other hand, a processing status (busy status) of the secure token encapsulated by the APDU is held in the status register 37. An APDU busy signal 38 is output from the status register 37.

The APDU busy signal 38 and the busy signal output from the write busy register 36 are supplied to the logic circuit 34. As described previously, the logic circuit 34 includes a busy output prolongation circuit, and the write busy signal is prolonged by a period corresponding to the APDU busy signal 38. That is, the logic circuit 34 continuously holds the output signal thereof at the low level when the write busy signal is brought from the active state into the inactive state, and the APDU busy signal 38 is brought from the inactive state into the active state.

The busy signal prolonged by the logic circuit 34 as described above is output from the output buffer 32 to the data signal line DAT0.

Incidentally, in the third embodiment, the APDU busy signal can be output also to the data signal line DAT1 as will be described below.

Further, in the case of the block write command (CMD25) in which the number of blocks to be transferred is not defined in an argument, the write operation is stopped by the stop command (CMD12) at an end of transfer of the block, as described previously. The status of the processing of writing data to the NAND memory 2 by the stop command (CMD12) is also held in the status register 37. A write error signal 41 is output from the status register 37.

When the busy error output capability register 43 is set in an on state (enable), the logic circuit 44 outputs the APDU busy signal 38 or the write error signal 41 selected by the logic circuit 42. The output signal of the logic circuit 42 is supplied to the data signal line DAT1 through the logic circuit 45 and the output buffer 32.

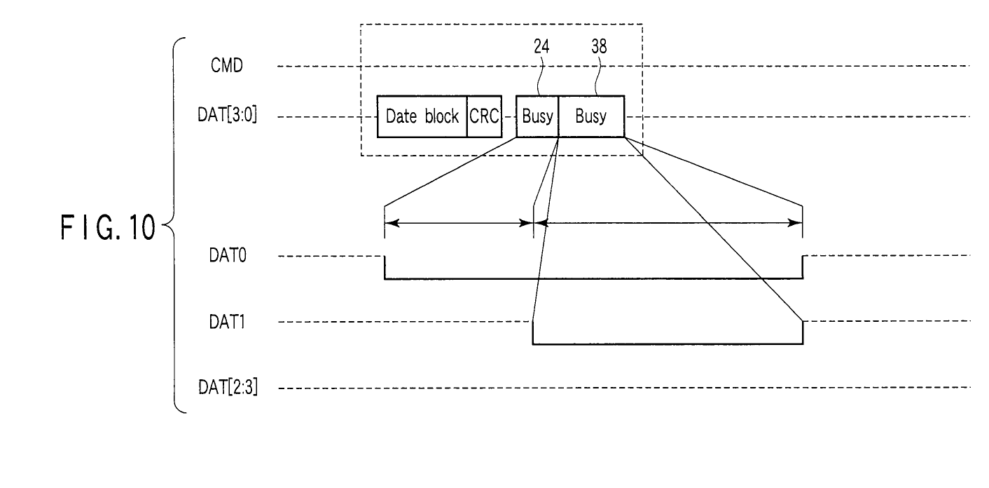

FIG. 10 is a view showing the output timing of the APDU busy interrupt signal according to the third embodiment.

As shown in FIG. 10, the busy signal 38 indicating the APDU processing period 26 is output to the data signal line DAT0 subsequently to the busy signal 24 of the buffer memory 6, and the busy signal 38 indicating the APDU processing period 26 is also output to the data signal line DAT1. That is, a busy signal 31 formed by prolonging the busy signal 24 of the buffer memory 6 by a period corresponding to the APDU processing period 26 is output to the data signal line DAT0. Further, the busy signal 38 indicating the APDU processing period 26 is output to the data signal line DAT1.

The output of the write error signal as the error status is as described by using FIG. 8.

According to the third embodiment described above, the same effect as the first and second embodiments can be obtained.

Furthermore, according to the third embodiment, a high-performance SD memory card can be realized by a circuit configuration on a relatively small scale.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory card comprising:
a nonvolatile memory;
a control section configured to control the nonvolatile memory;
a plurality of data terminals connected to a host, configured to transfer and receive data to and from the host;
a command terminal connected to the host,
configured to transfer and receive a command to and from the host; and
a buffer memory configured to temporarily store the data, wherein
the control section outputs a filled state of the buffer memory to a first data terminal of the plural data terminals as a write busy signal indicating a write busy period by a block write command operation in which the number of blocks to be transferred is defined,
receives a token issued by the block write command, and outputs the write busy signal indicating the write busy period to the first data terminal until an end of the token processing.

2. The memory card according to claim 1, wherein the control section further includes
a status register, the status register holding at least a busy signal indicating a busy status of the buffer memory, a write busy signal indicating a write processing state of the nonvolatile memory, and an APDU busy signal indicating a processing status of the block write command;
a write busy register holding a copy of the write busy signal held in the status register;
a first logic circuit configured to select and output one of an output signal of the status register, and output data of the buffer memory;
a second logic circuit configured to select and output one of an output signal of the write busy register, and the ADPU busy signal output from the status register; and
a third logic circuit configured to select one of output signals of the first and second logic circuits, and to supply the selected output signal to the first data terminal.

3. A memory card comprising:
a nonvolatile memory;
a control section configured to control the nonvolatile memory;
a plurality of data terminals connected to a host, configured to transfer and receive data to and from the host;
a command terminal connected to the host, configured to transfer and receive a command to and from the host; and
a buffer memory configured to temporarily store the data, wherein
the control section outputs a filled state of the buffer memory to a first data terminal of the plural data terminals as a write busy signal indicating a write busy period by a block write command operation in which the number of blocks to be transferred is defined,
receives a token issued by the block write command, and outputs a busy signal indicating a processing period of the token to a second data terminal of the plural data terminals.

4. The memory card according to claim 3, wherein the control section further includes
a status register, the status register holding at least a busy signal indicating a busy status of the buffer memory, a write busy signal indicating a write processing state of the nonvolatile memory, and an APDU busy signal indicating a processing status of the block write command;
a write busy register holding a copy of the write busy signal held in the status register;
a first logic circuit configured to select and output one of an output signal of the status register, and output data of the buffer memory;
a second logic circuit configured to select one of an output signal of the write busy register, and an output signal of the first logic circuit, and to supply the selected output signal to the first data terminal;
a third logic circuit configured to output one of the APDU busy signal and the write error signal held in the status register; and
a fourth logic circuit configured to select one of the output signal of the first logic circuit, and an output signal of the third logic circuit, and to output the selected output signal to the second data terminal.

5. The memory card according to claim 4, wherein the control section further includes
a register configured to hold data for switching output capability of data; and
a fifth logic circuit to which the output signal of the third logic circuit, and an output signal of the register are supplied, the fifth logic circuit supplying the output signal of the third logic circuit to the fourth logic circuit when the output signal of the register indicates an enabled state.

6. A memory card comprising:
a nonvolatile memory;
a control section configured to control the nonvolatile memory;
a plurality of data terminals connected to a host, configured to transfer and receive data to and from the host;
a command terminal connected to the host, configured to transfer and receive a command to and from the host; and
a buffer memory configured to temporarily store the data, wherein
the control section outputs a filled state of the buffer memory to a first data terminal of the plural data terminals as a write busy signal indicating a write busy period by a block write command operation in which the number of blocks to be transferred is defined,
receives a token issued by the block write command, outputs a write busy signal indicating the write busy period to the first data terminal until an end of token processing, and outputs a busy signal indicating a processing period of the token to a second data terminal of the plural data terminals.

7. The memory card according to claim 6, wherein the control section further includes
a status register, the status register holding at least a busy signal indicating a busy status of the buffer memory, a write busy signal indicating a write processing state of the nonvolatile memory, and an APDU busy signal indicating a processing status of the block write command;
a write busy register holding a copy of the write busy signal held in the status register;
a first logic circuit configured to select and output one of an output signal of the write busy register, and an APDU busy signal output from the status register;
a second logic circuit configured to select and output one of an output signal of the status register, and output data of the buffer memory;
a third logic circuit configured to select one of an output signal of the first logic circuit, and an output signal of the second logic circuit, and to supply the selected output signal to the first data terminal;
a fourth logic circuit configured to output one of the APDU busy signal and the write error signal held in the status register; and
a fifth logic circuit configured to select one of the output signal of the second logic circuit and an output signal of the fourth logic circuit, and to output the selected output signal to the second data terminal.

8. The memory card according to claim 7, wherein the control section further includes
a register configured to hold data for switching output capability of data; and
a sixth logic circuit to which the output signal of the fourth logic circuit, and an output signal of the register are supplied, the sixth logic circuit supplying the output signal of the fourth logic circuit to the fifth logic circuit when the output signal of the register indicates an enabled state.

9. The memory card according to claim 6, wherein
the control section outputs a filled state of the buffer memory to the first data terminal of the plural data terminals as a write busy signal indicating a write busy period by a block write command operation in which the number of blocks to be transferred is not defined, and
outputs, after a stop command, a write error signal indicating a write error status to the second data terminal of the plural data terminals.

10. The memory card according to claim 9, wherein the control section further includes
a status register, the status register holding at least a busy signal indicating a busy status of the buffer memory, a write busy signal indicating a write processing state of the nonvolatile memory, and an APDU busy signal indicating a processing status of the block write command;
a write busy register holding a copy of the write busy signal held in the status register;
a first logic circuit configured to select and output one of an output signal of the status register, and output data of the buffer memory;
a second logic circuit configured to select one of an output signal of the write busy register, and an output signal of the first logic circuit, and to supply the selected output signal to the first data terminal;
a third logic circuit configured to output one of the APDU busy signal, and the write error signal held in the status register; and
a fourth logic circuit configured to select one of the output signal of the first logic circuit, and an output signal of the third logic circuit, and to output the selected output signal to the second data terminal.

11. The memory card according to claim 10, wherein the control section further includes
a register configured to hold data for switching output capability of data; and
a fifth logic circuit to which the output signal of the third logic circuit, and an output signal of the register are supplied, the fifth logic circuit supplying the output signal of the third logic circuit to the fourth logic circuit when the output signal of the register indicates an enabled state.
